(19) United States
(12) Patent Application Publication
(10) Pub. No.: US 2011/0163650 A1
(43) Pub. Date: Jul. 7, 2011

(54) LAMP TOOL HAVING LIGHT SHIELDING EFFECT

(76) Inventor: Hung-Wen LEE, Taipei City (TW)

(21) Appl. No.: 12/683,693

(22) Filed: Jan. 7, 2010

(51) Int. Cl. H01J 5/16

(52) U.S. Cl. 313/113

(57) ABSTRACT

The present invention relates to a lamp tool having light shielding effect, comprises: a lamp housing, in a spherical shape, an inner end and/or an outer end thereof is processed with an etching treatment by a chemical agent so an irregular concave-convex shape is formed on the surface thereof, so that the lamp housing is provided with more projection angles for diffusing lights so as to increase the brightness, and a longitudinal hemisphere of the lamp housing is coated with a metal layer for refracting lights, and the rough surface is served to diffuse lights; an illumination portion disposed in the lamp housing for illumination; and a lamp head connected to the lamp housing and coupled to the illumination portion for being inserted into a lamp seat so the required power is able to be obtained for illumination. So light is able to be diffused by the rough surface and to be refracted by the metal layer.

### BACKGROUND OF THE INVENTION

1. Field of the Invention

The present invention relates to a lamp tool having light shielding effect, more particularly to a lamp tool having light shielding effect on which a lamp housing is installed and processed with an etching treatment by a chemical agent so the surface thereof is formed in a concave-convex shape so that the lamp housing is provided with more projection angles for diffusing lights so as to increase the brightness, and a metal layer is coated on the lamp housing for refracting lights.

2. Description of Related Art

The lamp housing of a conventional incandescent light bulb is transparent so lights emitted by filament is able to be transmitted through the lamp housing for achieving a purpose of illumination; or the lamp housing of a conventional energy-saving light bulb is coated with a thin white layer for preventing lights emitted by filament directly projecting to human eyes which may cause vision damage.

In the two mentioned light bulb structures, surfaces of the lamp housings are very smooth so a light diffusion effect is unable to be provided; and the two mentioned light bulb structures are not able to refract lights to a specific area or in a specific direction.

### SUMMARY OF THE INVENTION

One primary object of the present invention is to provide a lamp tool having light shielding effect, wherein a lamp housing thereof is processed with an etching treatment by a chemical agent so the surface thereof is formed in a concave-convex shape so that the lamp housing is provided with more projection angles for diffusing lights so as to increase the brightness.

Another object of the present invention is to provide a lamp tool having light shielding effect, wherein a metal layer is coated on a lamp housing for refracting and shielding lights.

For achieving the objects mentioned above, the present invention provides a lamp tool having light shielding effect, comprises: a lamp housing, in a spherical shape, an inner end and/or an outer end thereof is processed with an etching treatment by a chemical agent so an irregular concave-convex shape is formed on the surface thereof, so that the lamp housing is provided with more projection angles for diffusing lights so as to increase the brightness, and a longitudinal hemisphere of the lamp housing is coated with a metal layer for refracting lights, and the rough surface is served to diffuse lights; an illumination portion disposed in the lamp housing for illumination; and a lamp head connected to the lamp housing and coupled to the illumination portion for being inserted into a lamp seat so the required power is able to be obtained for illumination.

### BRIEF DESCRIPTION OF THE DRAWINGS

FIG. 1 is a schematic exploded view of the lamp tool having light shielding effect of one preferred embodiment of the present invention.

FIG. 2 is a schematic view of the assembly of the lamp tool having light shielding effect of one preferred embodiment of the present invention.

### DETAILED DESCRIPTION OF THE PREFERRED EMBODIMENT

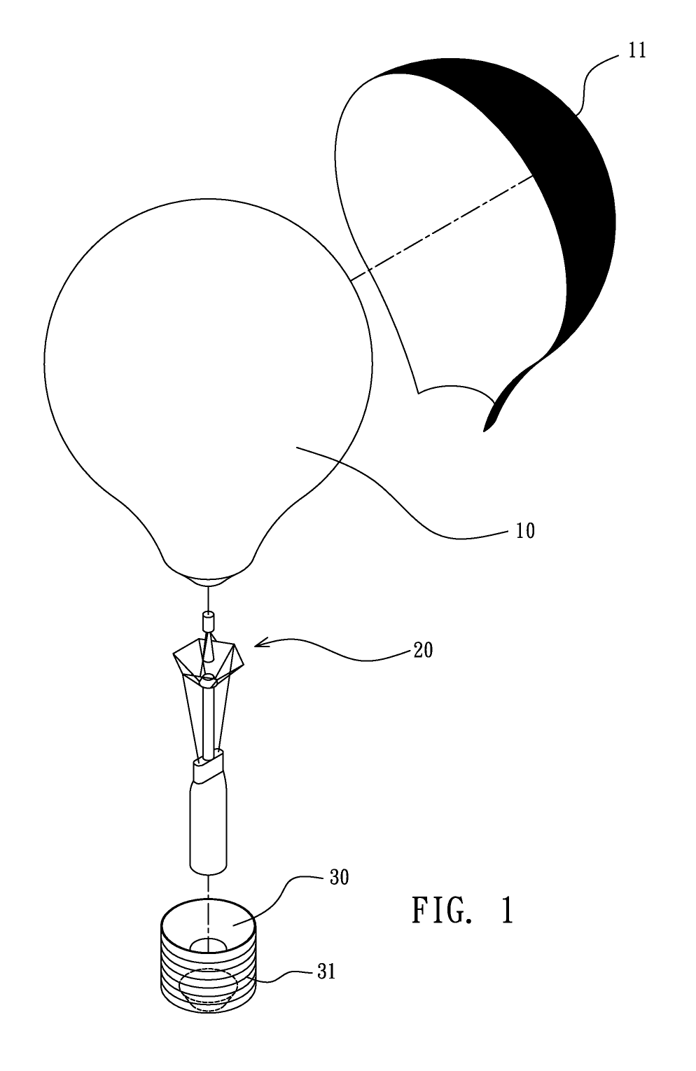

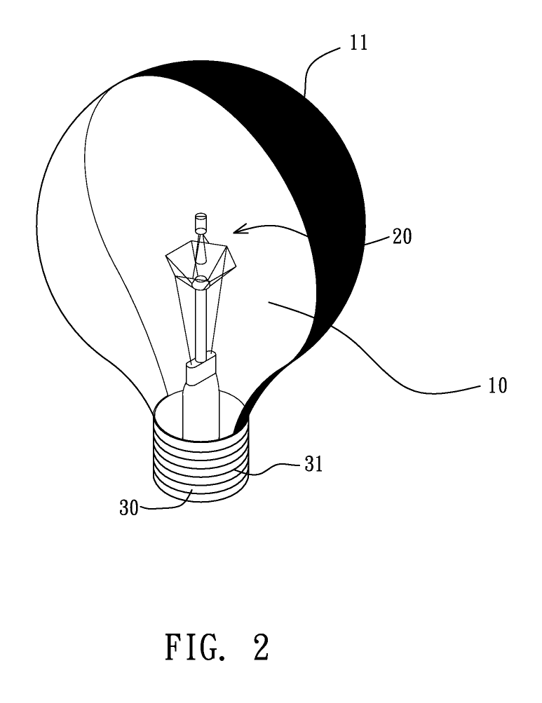

Referring to FIG. 1 and FIG. 2, wherein FIG. 1 is a schematic exploded view of the lamp tool having light shielding effect of one preferred embodiment of the present invention; and FIG. 2 is a schematic view of the assembly of the lamp tool having light shielding effect of one preferred embodiment of the present invention.

As shown in figures, the lamp tool having light shielding effect provided by the present invention comprises: a lamp housing 10; an illumination portion 20; and a lamp head 30.

The lamp housing 10 is made of, e.g. but not limited to, glass or plastic material and is preferably fabricated to a spherical shape; an inner and/or an outer end thereof is processed with an etching treatment by a chemical agent, so an irregular concave-convex shape is formed on the surface thereof, so that the lamp housing 10 is provided with more projection angles for diffusing lights so as to increase the brightness, wherein the chemical agent is, e.g. but not limited to, hydrofluoric acid or hydrofluoric hydroammonia. A longitudinal hemisphere of the lamp housing 10 is coated with a metal layer 11, e.g. but not limited to a gold-coated layer or a silver-coated layer, the metal layer 11 is served to refract lights so that lights illuminated by the illumination portion 20 are completely transmitted through the other hemisphere of the lamp housing 10 so as to achieve effects of light shielding and diffusing. The lamp housing 10 is, e.g. but not limited to, a G type, PS type, DP type, C type, S type, T type, ST type or R type lamp housing.

The illumination portion 20 is, e.g. but not limited to, a tungsten filament or light emitting diode; in this embodiment, tungsten filament is adopted for illustration but not served as a limitation, and said tungsten filament is disposed inside the lamp housing 10 for providing illumination.

The lamp head 30 is connected to the lamp housing 10 and coupled to the illumination portion 20 for being inserted into a lamp seat (not shown), so the required power is able to be obtained for illumination. The lamp head 30 is, e.g. but not limited to, an E26 or E27 lamp head, and an outer end thereof is further installed with thread 31 for being screw-fitted with the lamp seat.

In operation, the lights illuminated by the illumination portion 20 of the present invention are omnidirectionally diffused by the concave-convex surface formed on the lamp housing 10, and the metal layer 11 installed on the other longitudinal hemisphere of the lamp housing 10 is served to refract the lateral lights, so the lateral light leakage is prevented and the light intensity of the other hemisphere is also enhanced. Therefore the lamp tool having light shielding effect provided by the present invention is able to solve disadvantages of conventional light bulbs.

As mentioned above, compared to conventional light bulbs, the lamp tool having light shielding effect provided by the present invention has following advantages: 1. the lamp housing is processed with an etching treatment by a chemical agent so that the lamp housing is provided with more projection angles for diffusing lights so as to increase the brightness; 2. a metal layer is coated on the lamp housing for refracting and shielding lights. Therefore the lamp tool having light shielding effect provided by the present invention is novel compared to conventional incandescent light bulbs.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lamp tool having light shielding effect, comprising:
a lamp housing, in a spherical shape, an inner end and/or an outer end thereof is processed with an etching treatment by a chemical agent so an irregular concave-convex shape is formed on the surface thereof, so that said lamp housing is provided with more projection angles for diffusing lights so as to increase the brightness, and a longitudinal hemisphere of said lamp housing is coated with a metal layer for refracting lights, and the rough surface is served to diffuse lights;
an illumination portion disposed in said lamp housing for illumination; and
a lamp head connected to said lamp housing and coupled to said illumination portion for being inserted into a lamp seat so the required power is able to be obtained for illumination.

2. The lamp tool having light shielding effect as claimed in claim 1, wherein said lamp head is a E26 or E27 lamp head.

3. The lamp tool having light shielding effect as claimed in claim 1, wherein said lamp housing is made of glass or plastic material.

4. The lamp tool having light shielding effect as claimed in claim 1, wherein said chemical agent is hydrofluoric acid or hydrofluoric hydroammonia.

5. The lamp tool having light shielding effect as claimed in claim 1, wherein said lamp housing is a G type, PS type, DP type, C type, S type, T type, ST type or R type lamp housing.

6. The lamp tool having light shielding effect as claimed in claim 1, wherein said metal layer is a gold-coated layer or silver-coated layer.

7. The lamp tool having light shielding effect as claimed in claim 1, wherein said illumination portion is a tungsten filament or light emitting diode.
